(19) United States
(12) Patent Application Publication
(10) Pub. No.: US 2011/0148756 A1
(43) Pub. Date: Jun. 23, 2011

(54) NAVIGATION AND SELECTION CONTROL FOR A WIRELESS HANDSET

(76) Inventors: Glen Allen Oross, San Diego, CA (US); Susan McKinney, Encinitas, CA (US)

(21) Appl. No.: 12/645,468

(22) Filed: Dec. 22, 2009

(51) Int. Cl. G06F 3/033; G06F 3/041; G09G 5/00

(52) U.S. Cl. 345/157; 345/173; 345/156; 455/566

(57) ABSTRACT

A user input device for a wireless handset and a method for receiving user input on a wireless handset is described. The user input device comprises a trackpad and a selection button. The wireless handset has a display that presents a graphical user interface. The graphical user interface is updated in accordance with input received at the user input device.

### FIELD

The present invention relates to a user input device for a wireless handset and method for receiving user input on a wireless handset. More particularly, the invention relates to a user input comprising a trackpad and a selection button.

### BACKGROUND

At present, wireless handsets lack a practical method to quickly and efficiently navigate a graphical user interface. Many wireless handsets feature a navigation key to allow a user to navigate graphical user interfaces. The navigation key typically includes a multi-directional control for navigation and a separate control for selection. A navigation key input requires a user to click the navigation key repeatedly to move through menu options in a displayed menu. Similarly, moving a cursor through a document requires continual clicking of the navigation key, which may become particularly tedious when a long document is involved. Paging through a lengthy webpage may also require a time-consuming series of clicks.

A touch screen interface provides an alternative navigation system for a graphical user interface displayed on a wireless handset. The lack of a selection button on a touch screen device inhibits operation of the device. The user does not receive tactile feedback to indicate that a selection has been made. Furthermore, selection must be made by tapping the touch screen rather than clicking a selection button. It may be difficult for users to accurately position a cursor or make selections when a selection button is not provided.

### SUMMARY

A wireless handset with a user input device that allows navigation and selection is described. A method for receiving user input with a trackpad and selection button is also described. In a first illustrative embodiment, the wireless handset includes a processor and a user input device operatively coupled to the processor. The user input device comprises a trackpad and a selection button. The wireless handset also includes a display that is operatively coupled to the processor. The display presents a graphical user interface. The user input device allows a user to navigate the graphical user interface.

In another illustrative embodiment, the wireless handset includes a processor and a user input device comprising a means for navigation and a means for selection. The means for navigation includes a sensor capable of sensing a contact with a surface of a sensor pad. The means for selection includes a mechanical input device.

A method for interfacing with a wireless handset is also described. The method comprises displaying a user interface on a display of the wireless handset. The method continues by using a trackpad to sense the direction of a contact a user makes with a trackpad surface. The method then receives a selection input when the user operates a selection button.

### DRAWINGS

The embodiments will be more fully understood by reference to the following drawings which are for illustrative, not limiting, purposes.

FIGS. 1A-1B show an illustrative clamshell format wireless handset.

FIG. 2 shows an illustrative wireless touch screen format wireless handset, in accordance with an embodiment.

FIGS. 3A-3B show an illustrative wireless handset having a user input device located on the posterior face of a wireless handset.

FIG. 4A shows an illustrative user input device according to an illustrative embodiment.

FIG. 4B shows a cross section of the user input device shown in FIG. 4A.

FIG. 5A shows an illustrative user input device according to another illustrative embodiment.

FIG. 5B shows a cross section of the user input device shown in FIG. 5A.

FIG. 6 shows an illustrative communication system, in which the wireless handset features a display and user input device operatively coupled to a processor.

FIG. 7 shows an illustrative flow chart for interfacing with a wireless handset using the user input device.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the wireless handset, systems, and methods described hereinafter may vary as to configuration and as to details.

A user input device for a wireless handset and a method for receiving user input on a wireless handset is described. The user input device comprises a trackpad and a selection button.

A trackpad is a sensor capable of sensing a contact with the surface of the sensor. The trackpad may be capable of sensing, for example, a position of contact with the trackpad surface or a direction of contact with the trackpad surface or the combination thereof. For example, when a user slides a finger across the trackpad surface, the trackpad may sense to direction of the contact between the finger and the trackpad surface. The trackpad may be capable of sensing contact of a stylus with the trackpad surface. Multiple contacts, such as the contact of multiple fingers with the trackpad surface, may be sensed by the trackpad. A trackpad sensor system may use a capacitive sensor to determine when contact has been made with the trackpad surface.

The selection button is a mechanical button on the wireless handset. The selection button of the user interface device may be located proximate to the trackpad to allow a user to efficiently alternate between using the trackpad and using the selection button. The selection button may provide tactile feedback to the user when the selection button is operated. For example, the selection button, when operated, may produce a click that is audible or detectible by tactile perception or a combination thereof. In one embodiment, the selection button is a rim surrounding the trackpad. The rim may extend above the surface of the trackpad to allow the user to easily distinguish by feel between the trackpad surface and the selection button. In another embodiment, the selection button is contiguous with the trackpad, such that the selection button is operated by depressing the trackpad.

The selection button comprises a mechanical actuator, a popple dome, and a printed circuit board (PCB). The popple dome comprises an electrically conductive material. When the mechanical actuator is depressed, it comes into contact with the popple dome, causing the popple dome to move toward the PCB. When the popple dome comes into contact with the PCB, a circuit is completed, resulting in activation of the switch corresponding to the selection button.

The wireless handset comprises a processor and a display operatively coupled to the processor. The display may present a graphical user interface. The graphical user interface may include at least one menu with a plurality of menu items. An active menu item is the item that will be selected if the selection button is pressed. The active menu item may be indicated by highlighted text associated with the active menu item.

The display may present a cursor. A cursor shows the position on the display where text manipulation may occur. The cursor may be shown, for example, as a blinking vertical line.

The display may present a pointer. The pointer may be indicated by an icon such as an arrow. The pointer indicates a selected position on the display of the wireless handset. The area under the pointer will be active when the selection button is pressed. The pointer may be used, for example, to select a menu item from a menu or to control the position of a cursor.

When a contact with the trackpad is detected, the graphical user interface is changed relative to the contact. For example, when a user slides a finger across the trackpad, the trackpad senses the contact. As the position of the contact changes during the sliding gesture, coordinates of the contact as sensed by the trackpad are sent to a processor. The processor derives the direction of the motion from the change in the coordinates of the contact over time. The processor updates the graphical user interface is relative to the changing position of contact.

In an illustrative example, a menu is displayed on the wireless handset. A first menu item is highlighted to indicate that it is the active menu item. A user contacts the trackpad with a finger and slides the finger in a downward motion from an upper portion of the trackpad to a lower portion of the trackpad. In response to the contact, the displayed menu may change such that the first menu item ceases to be the active menu item and a second menu item displayed below the first menu item becomes the active menu item as indicated by highlighted menu item text. When the user operates the selection button, the active menu item is selected.

In another illustrative example, a cursor is displayed on the wireless handset. When the user contacts the trackpad by sliding a finger across the trackpad, the user interface is updates such that the cursor is moved in the direction of the contact. Text may then be manipulated at the point where the cursor is positioned.

In a further illustrative example, the display shows a pointer. As the user slides a finger across the trackpad, the graphical user interface is updated such that the pointer moves in the direction of the contact. For example, in a text application such as a word processing application, the pointer controls a cursor. The user slides a finger across the trackpad to move the pointer. The position of the pointer on the display changes relative to the movement of the finger across the trackpad. In this manner, the user moves the pointer to a desired position within a block of text. The user then presses the select button to position the cursor at the pointer location on the display. The user may subsequently manipulate text at the cursor position. In another example, the display shows a menu. The user controls the movement of the pointer relative to the menu items. The user may position the pointer over a desired menu item. The user then presses the select button to select the desired menu item.

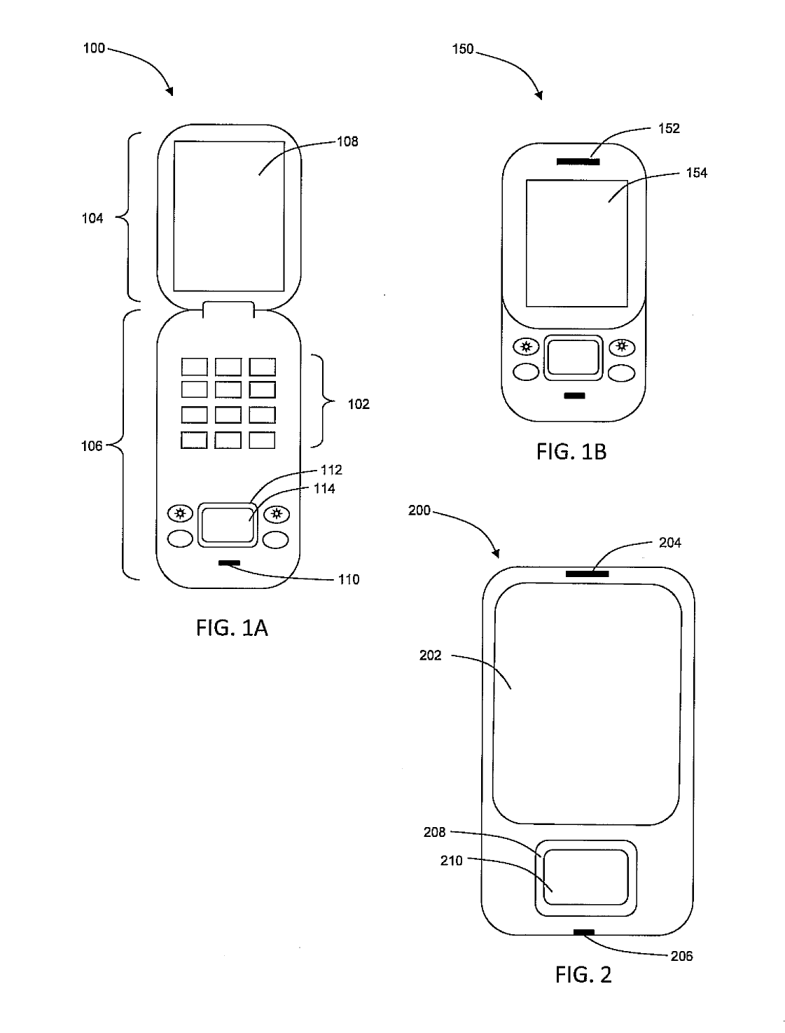

Referring to FIGS. 1A-1B, there are shown wireless handsets 100 and 150. The illustrative wireless handset can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system.

FIG. 1A shows an illustrative clamshell format wireless handset featuring a numeric keypad 102. The wireless handset may be another format of wireless handset featuring a numeric keypad or alphanumeric keypad, for example a bar format wireless handset. The wireless handset includes a display 102, an antenna (not shown), a microphone 110, and a speaker 152 (shown in FIG. 1B). The wireless handset further a user input device comprising trackpad 114 and selection button 112.

In FIG. 1A, the clamshell format wireless handset 100 is shown in an open position. Referring now to FIG. 1B, upper segment 104 of the wireless handset may be folded over lower segment 106 of the wireless handset, resulting in the closed position 150 of wireless handset 100.

The wireless handset may have a second display 154 located on the posterior face of the upper segment 104 of the handset. Display 154 may present a secondary graphical user interface. The user input device is located such that it is accessible when the wireless handset is in a closed position as illustrated in FIG. 1B. This may allow a user to control a graphical user interface shown on display 154 with the user input device while the wireless handset is in the closed position.

Referring to FIG. 2, an illustrative wireless handset 200 with a display 202 is shown. The display 202 may be a touch screen display. The touch screen display is a user interface that allows the user to control the wireless handset by touching the surface of the display. The wireless handset includes speaker 204, microphone 206, and an antenna (not shown). The wireless handset may also have a user input device comprising trackpad 206 and select button 204. The user input device provides an additional means for controlling the wireless handset.

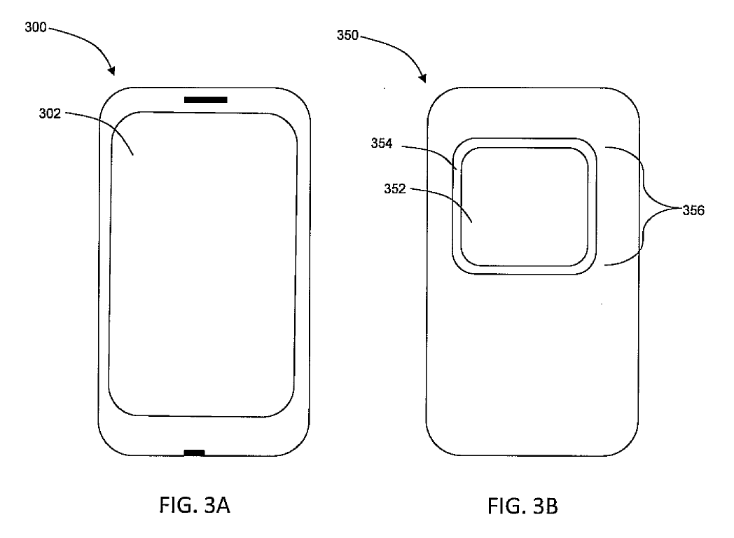

Referring to FIGS. 3A-3B, yet another illustrative wireless handset is shown. The wireless handset includes display 302 as shown in FIG. 3A. In some embodiments, display 302 may be a touch screen display. Wireless handset 300 may additionally comprise a keypad (not shown). FIG. 3B shows the posterior face 350 of wireless handset 300. The wireless handset 300 includes a user input device on the posterior face 350 of the wireless handset. The user input device comprises trackpad 354 and selection button 352. The user of the wireless handset shown in FIGS. 3A-3B will typically hold the phone in a hand with the display 302 facing upwards. The user manipulates the user input device on the posterior face 350 of the wireless handset while looking at the display 302 on the anterior face 300 of the device.

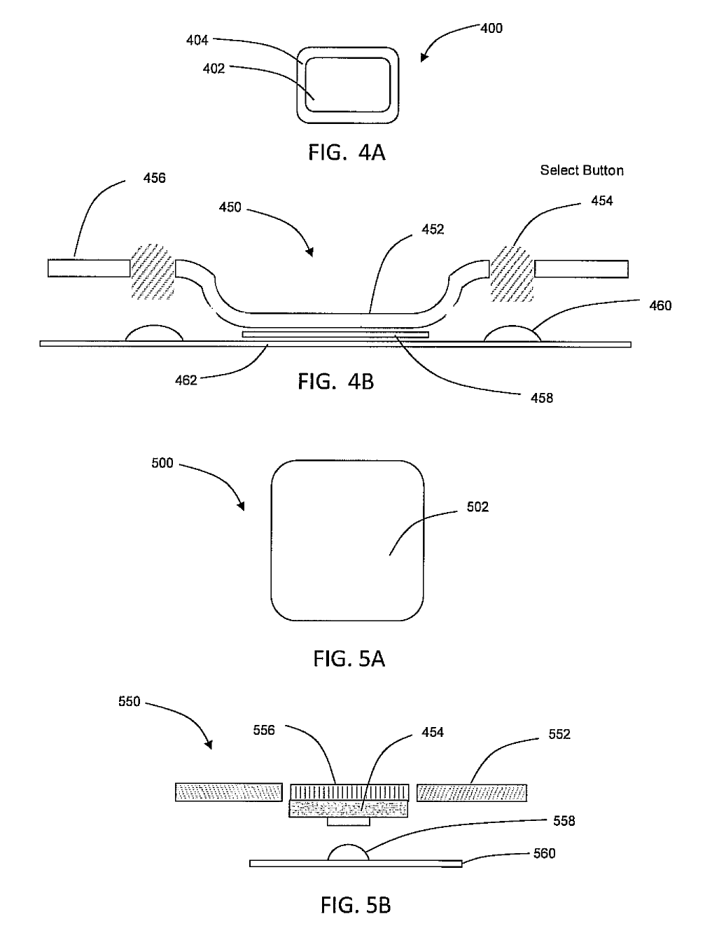

Referring to FIGS. 4A-4B, an illustrative user input device is shown according to one embodiment. FIG. 4A shows the user input device 400. The user input device 400 comprises trackpad 402 and selection button 404. FIG. 4B shows a cross-sectional view 450 of user input device 400. The trackpad is shown in cross section at 452 and the selection button is shown in section at 454. The user input device is seated in a housing 456. The housing may be, for example, a plastic housing that fully or partially encloses the wireless handset.

Capacitive sensor 458 is capable of detecting a contact with the surface of trackpad 452. The capacitive sensor system is capable of detecting the position of a contact. The position of the contact may be determined as a set of coordinates in a two-axis system. Thus, if an x-axis runs vertically along trackpad 402 and a y-axis runs horizontally along trackpad 402, the x and y coordinates for a contact may be determined by the capcitive sensor system. In the case of a moving contact, such as a finger sliding along the trackpad surface, processor 614 may derive the direction of the motion from the position data produced by the trackpad sensor.

The selection button 404 of FIG. 4A is shown as a rim surrounding trackpad 402. Selection button 404 of FIG. 4A corresponds to selection button 454 of FIG. 4B. The selection button may extend above the surface of the housing 456 and above the surface of the trackpad 452, as shown in FIG. 4B. The raised selection button rim allows a user to easily detect the raised rim selection button by sense of touch. The selection button system comprises at least one popple dome 460 and printed circuit board (PCB) 452. The popple dome comprises a conductive material. When the user operates the selection button by pressing selection button 454 down toward the popple dome 460, the popple dome is urged toward PCB 452. When the popple dome contacts the PCB, a circuit is closed and a selection button switch is activated.

Referring to FIGS. 5A-5B, an illustrative embodiment of a user input device according to an embodiment is shown. FIG. 5A shows the user input device 500, comprising trackpad 502. The entire trackpad surface of user input device 500 functions as a selection button. Thus, a user may depress the trackpad at any point on the trackpad to operate the selection button.

FIG. 5B shows a cross-sectional view 550 of user input device 500. The user input device is seated in a housing 552. The housing may be, for example, a plastic housing that fully or partially encloses the wireless handset. Capacitive sensor 554 is capable of detecting a contact with the surface of trackpad 556.

The selection button system comprises at least one popple dome 558 and PCB 560. The popple dome comprises a conductive material. When the user operates the selection button by depressing trackpad surface 556 down toward the popple dome 558, the popple dome is urged toward PCB 560. When the popple dome contacts the PCB, a circuit is closed and a selection button switch is activated.

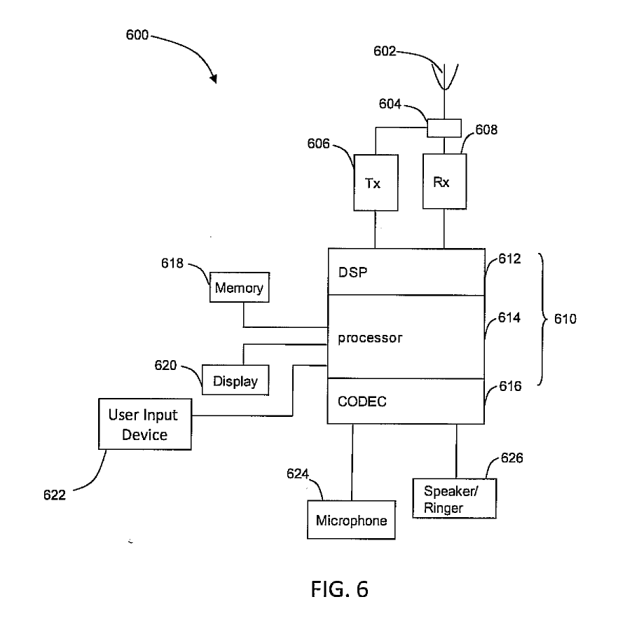

Referring to FIG. 6, there is shown a plurality of components associated with an illustrative wireless handset. The illustrative wireless handset 600 comprises a first antenna element 602 that is operatively coupled to a duplexer 604, which is operatively coupled to a transmitter module 606, and a receiver module 608.

An illustrative control module 610 comprises a digital signal processor (DSP) 612, a processor 614, and a CODEC 616 that are communicatively coupled to the transmitter 606 and receiver 608. It shall be appreciated by those of ordinary skill in the art that the transmitter module and receiver module are typically paired and may be embodied as a transceiver. The DSP 610 may be configured to perform a variety of operations such as controlling the antenna 602, the transmitter module 204, and the receiver module 608.

The processor 614 is operatively coupled to memory 618, display 620, and user input device 622. Additionally, the processor 614 is also operatively coupled to a CODEC module 616 that performs the encoding and decoding operations and is communicatively coupled to microphone 624 and a speaker or ringer 626. The CODEC module 616 is also communicatively coupled to the display 620 and provides the encoding and decoding operations for video.

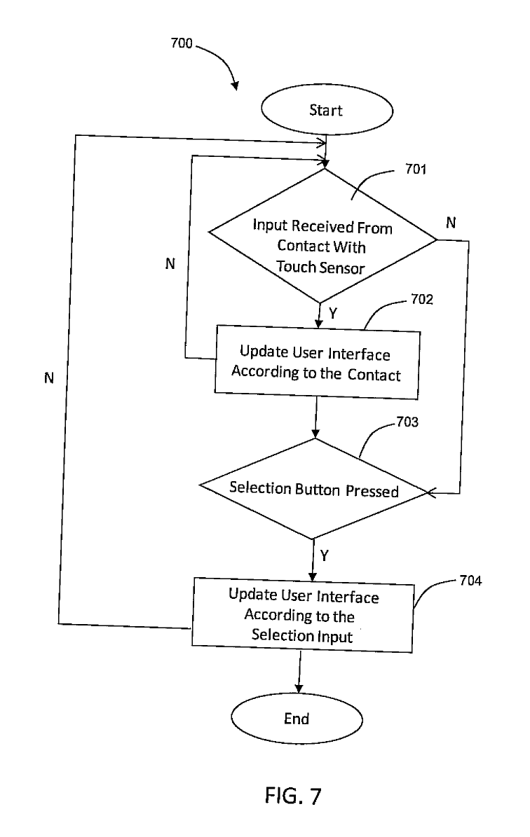

Referring to FIG. 7, there is shown an illustrative flowchart 700 of the method for interfacing with a wireless handset using the user input device. The illustrative flowchart is initiated at decision diamond 701, in which wireless handset processor 614 determines whether a contact has been detected at the user input device. If a contact has been detected, the user interface shown on display 620 is updated in accordance with the contact. The user interface may be updated in accordance with the position and direction of the contact as described in block 702. For example, the display may present a menu, a cursor, or a pointer, as described above. The position and direction of the input determines the change in the user interface shown on the display as described above.

At decision diamond 703, the wireless handset processor 614 determines whether the selection button has been pressed. If the selection button has been pressed, the user interface is updated in accordance with the selection input at block 704. For example, when the selection button is pressed, an active menu item may be selected when the selection button is pressed, as described in more detail above.

A user input device and a method for receiving user input on a wireless handset has been described above. The user input device comprises a trackpad and a a selection button. A graphical user interface presented on a display of the wireless handset is navigated by contact with the trackpad surface. The user may contact the trackpad by sliding a finger across the trackpad surface. The graphical user interface is updated relative to the direction of the contact. The user may indicate a selection by operating the selection button.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope is determined by the following claims and their legal equivalents.

What is claimed is:

1. A wireless handset, comprising:
a processor to support a plurality of functions to be performed by the handset;
a user input device operatively coupled to the processor, the user input device comprising a selection button and a trackpad capable of sensing a contact with a trackpad surface; and
a display operatively coupled to the processor, wherein the display presents a user interface configured to receive commands from the user input device.

2. The user interface of claim 1, wherein the selection button comprises a rim surrounding the trackpad surface.

3. The user interface of claim 1, wherein the selection button comprises the trackpad surface.

4. The wireless handset of claim 1, wherein the user input device is located on the anterior face of the wireless handset.

5. The wireless handset of claim 1, wherein the user interface comprises a cursor responsive to an input communicated to the user input device.

6. The wireless handset of claim 1, wherein the user interface comprises a menu with a plurality of menu items.

7. The wireless handset of claim 6, wherein the menu items are selectable responsive to an input communicated to the user input device.

8. A wireless handset, comprising:
a processor to support a plurality of functions to be performed by the handset
a user input device operatively coupled to the processor, the user input device comprising a means for navigation and a means for selection;
wherein the means for navigation comprises a sensor for sensing a contact with a surface of a sensor pad;
wherein the means for selection comprise a mechanical input device; and
a display operatively coupled to the processor, wherein the display presents a user interface configured to receive commands from the user input device.

9. The user interface of claim 8, wherein the means for selection comprises a rim surrounding the contact sensing device.

10. The user interface of claim 8, wherein the means for selection comprises the contact sensing device.

11. The wireless handset of claim 8, wherein the user input device is located on the anterior face of the device.

12. The wireless handset of claim 8, wherein the user interface comprises a cursor responsive to an input communicated to the user input device.

13. The wireless handset of claim 8, wherein the display shows a cursor, user interface comprises a menu with a plurality of menu items.

14. The wireless handset of claim 13, wherein the menu items are selectable responsive to an input communicated to the user input device.

15. A method for interfacing with a wireless handset, the method comprising:
displaying a user interface on a display of the wireless handset;
sensing a contact with a trackpad surface;
updating the user interface according to the direction of the contact;
receiving a selection input from a selection button; and
updating the user interface according to the selection input.

16. The method of claim 15 further comprising activating the selection button by pressing a rim surrounding the touch sensor surface.

17. The method of claim 15 further comprising activating the selection button by pressing the touch sensor surface.

18. The method of claim 15, further comprising:
displaying a cursor;
updating the cursor position on the display relative to the direction of the contact with the trackpad surface.

19. The method of claim 15, further comprising displaying a menu comprising a plurality of menu items.

21. The method of claim 20, further comprising
indicating an active menu item;
changing the active menu item responsive to the direction of contact communicated to the user input device.

22. The method of claim 21, further comprising selecting an active menu item responsive to operation of the selection button.
